(19) United States
(12) Patent Application Publication
(10) Pub. No.: US 2008/0183921 A1
(43) Pub. Date: Jul. 31, 2008

(54) Serial advanced technology attachment (SATA) frame information structure (FIS) processing

(76) Inventors: Naichih Chang, Shrewsbury, MA (US); Pak-Lung Seto, Shrewsbury, MA (US)

Correspondence Address: INTEL CORPORATION;c/o INTELLEVATE, LLC, P.O. BOX 52050, MINNEAPOLIS, MN, 55402, US

(21) Appl. No.: 11/699,167

(22) Filed: Jan. 29, 2007

(51) Int. Cl. G06F 13/12

(52) U.S. Cl. 710/58

(57) ABSTRACT

A method and apparatus improves a link rate to a plurality of storage devices accessible through a port multiplier. An SATA/STP Transport Layer Transmit Processor in a FIS-based switching Port Multiplier system may service a next task to be transmitted to a next device accessible through the port multiplier even if the current task to a current device is stalled.

### FIELD

This disclosure relates to storage subsystems and in particular to improving the link rate to Serial Advanced Technology Attachment (SATA) protocol storage devices in a storage subsystem.

### BACKGROUND

Point-to-point storage protocols such as the Serial Advanced Technology Attachment (SATA) protocol support one active communication between a storage device and a host bus adaptor at a time. A port multiplier is a mechanism for one active host connection to communicate with multiple SATA devices. For example, a SATA II port multiplier allows a host bus adapter to concurrently communicate with up to 15 SATA devices through the use of multiplexing. The host bus adapter knows that it is communicating with multiple devices but the devices are unaware that they are being multiplexed. The multiplexing is performed through the use of a port multiplier port (PMP) field in a SATA Frame Information Structure (FIS). The port multiplier forwards SATA FISes from the host bus adapter to the devices based on the port multiplier port field. Thus, there may be pending commands for up to 15 different devices through the port multiplier.

Typically a host bus adapter may stall the transmit path after receiving a Direct Memory Access (DMA) Setup FIS or Set Device Bits (SDB) FIS with error or notification from a SATA device to achieve atomic Native Command Queuing (NCQ) data operation or to perform error or exception handling due to SATA specification requirements. This occurs in a Port Multiplier configuration even if the to-be-transmitted command is for a SATA device other than the SATA device from which the FIS was received. This results in reduced bandwidth because instead of using the transmit path to transmit to other SATA devices attached to the Port Multiplier, the transmit path is stalled which results in reducing the link rate.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system that includes an embodiment of a FIS type manager according to the principles of the present invention;

FIG. 2 is a block diagram of an embodiment of a system that includes an embodiment of the FIS type manager shown in FIG. 1;

FIG. 3 is a block diagram of an embodiment of the receive buffer shown in FIG. 2 which may store a plurality of received FISes or frames; and

FIG. 4 is a flow graph illustrating an embodiment of a method for managing transmission of FISes to SATA devices by monitoring received FISes stored in a receive buffer.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

A version of the SATA protocol is described in “Serial ATA: High Speed Serialized AT Attachment,” Revision 1.0a, published on Jan. 7, 2003 by the Serial ATA Working Group (hereinafter termed the “SATA standard”).

Storage protocols such as the SATA protocol support active communication between a storage device and a host bus adaptor (controller or host adaptor). The SATA protocol architecture defines four protocol layers: phy, link, transport and application. Phy layer functions include link level reset, initialization and speed negotiation which are performed using a phy reset sequence (Out of Band (OOB) sequence) and a speed negotiation sequence.

The link layer defines an encoding scheme in which information (data and control) is encoded into 10-bit characters using 8 b/10 b encoding. In 8 b/10 b encoding, eight bits are encoded at a time into a 10-bit character and then transmitted serially bit-by-bit across the physical link. Eight information bits and a control variable (value D-data, value K-control) is encoded into the 10-bit character. The link layer also performs flow control, data scrambling, Cyclic Redundancy Check (CRC) checking and reporting, etc.

The transport layer constructs Frame Information Structures (FISes) for transmission and decomposes received FISes. A FIS is the user payload of a frame.

In addition to the FIS, a frame includes primitives (Start of Frame (SOF_{P}), End of Frame (EOF_{P})) and a Cyclic Redundancy Check (CRC)).

A port multiplier is a mechanism for one active host connection to communicate with multiple SATA devices. For example, a SATA II port multiplier allows a host bus adapter to concurrently communicate with up to 15 SATA devices by multiplexing through the use of a port multiplier port field in a SATA Frame Information Structure (FIS). In a system having a Serial Advanced Technology Attachment (SATA), upper protocol layers such as a transport layer or an application layer may be busy from time to time. For example, upper layers may be busy due to task context fetching or updating, a Direct Memory Access (DMA) request, or frame or Input/Output (I/O) status validating. A receive buffer in the receive path can be used to accept incoming frames to increase utilization of the link or maintain the link rate even if the upper layer or the host interface are busy.

An embodiment of the present invention provides a mechanism for monitoring received SATA FISes or frames stored in a receive buffer in a receive path by a transmit path to reduce stalls in the transmit path and thus increase the link rate. The current task may be stalled due to reception of a SATA frame associated with a stall condition, for example, a DMA Setup FIS, Set Device Bits (SDB) FIS with error (that is, an SDB FIS with the error bit set), Set Device Bits (SDB) FIS with notification (that is, an SDB FIS with notification bit set) or other FIS that may result in a stall condition. In a port multiplier configuration, new commands or control tasks may be issued to devices in the transmit path even when a frame received from a device has stalled the transmit path to one of the devices.

A monitoring mechanism which may also be referred to as a ‘received FIS status look-ahead’ enables a SATA Tunneling Protocol (STP) Transport Layer Transmit Processor to continue servicing a next task to be transmitted to a next device even if the current task to a current device is stalled due to above mentioned reasons.

The monitoring mechanism enables the full utilization of the receive buffer or Receive First In First Out (FIFO) to fully utilize the link and maintain the link rate.

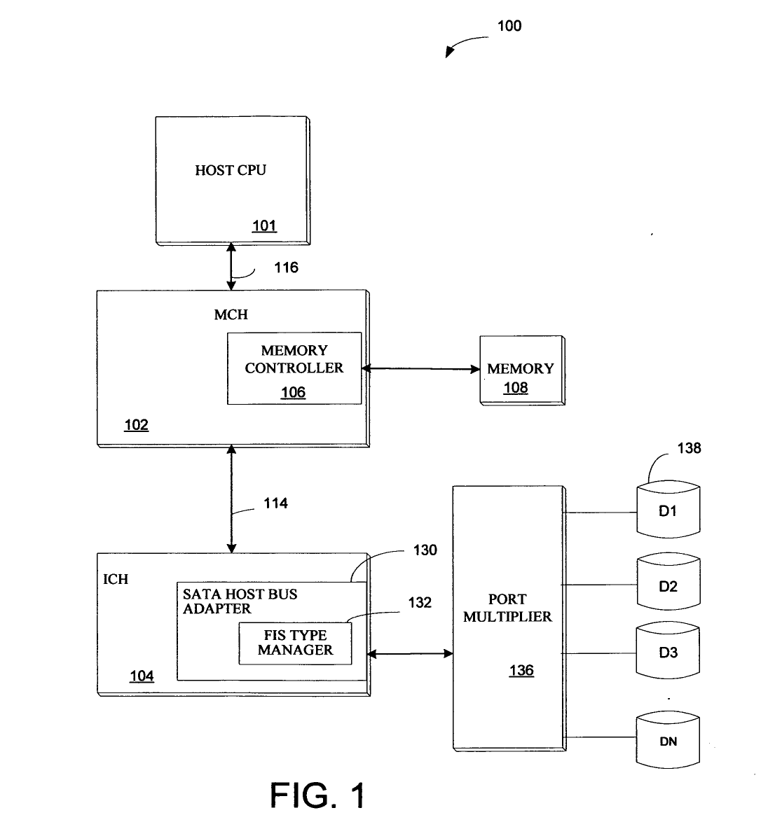

FIG. 1 is a block diagram of a system 100 that includes an embodiment of a FIS type manager 132 according to the principles of the present invention. The system 100 includes a Central Processing Unit (CPU) 101, a Memory Controller Hub (MCH) 102 and an I/O Controller Hub (ICH) 104. The MCH 102 controls communication between the CPU 101 and memory 108.

The Central Processing Unit (CPU) 101 may be any one of a plurality of processors such as a single core Intel® Pentium IV® processor, a single core Intel Celeron processor, an ® XScale processor or a multi-core processor such as Intel® Pentium D, Intel® Xeon® processor, or Intel® Core® Duo processor or other processor.

The memory 108 may be Dynamic Random Access Memory (DRAM), Static Random Access Memory (SRAM), Synchronized Dynamic Random Access Memory (SDRAM), Double Data Rate 2 (DDR2) RAM or Rambus Dynamic Random Access Memory (RDRAM) or any other type of memory.

The ICH 104 may be coupled to the MCH 102 using a high speed chip-to-chip interconnect 114 such as Direct Media Interface (DMI). DMI supports 2 Gigabit/second concurrent transfer rates via two unidirectional lanes. The CPU 101 and MCH 102 communicate over a system bus 116.

The ICH 104 includes a SATA host adaptor (controller or host bus adaptor) 130 for controlling communication with a storage device 138 coupled through a port multiplier 136 to the ICH 104. The SATA host adaptor 130 includes an embodiment of a FIS type manager 132 to reduce stalls in a transmit path to storage devices 138 through port multiplier 136.

In the embodiment shown, each storage device 138 coupled to the port multiplier 136 is a SATA device that supports Native Command Queuing (NCQ) which allows a plurality of commands to be queued in the SATA device 138. NCQ improves the performance of a SATA device 138 by allowing a SATA device 138 to optimize the execution order of read and write requests. Instead of executing commands in the order in which they are received, the SATA device's internal command queue may be reordered for optimal performance, for example, the commands may be reordered to reduce the amount of seek time in a hard drive based on the physical location of data in the read and write requests.

Through the use of NCQ, a SATA device 138 may maintain up to 32 pending commands and may order processing of those commands. Each queued command is identified by a tag value. In an embodiment in which there may be up to 32 pending commands, 32 bits (4-bytes) are provided in a Set Device Bits FIS which is sent from the SATA device 138 to convey the pending status of each of the 32 possible pending commands in the SATA device. The 32-bits are handled as a 32-bit element array of active command (SActive) bits, one for each possible pending command. Thus, the Set Device Bits FIS provides the status of pending commands that are queued in the SATA device 138. An NCQ tag is included in certain SATA FISes to identify the tag value assigned to the current command being sent to the SATA device.

The port multiplier 136 allows the host bus adapter 130 to concurrently communicate with a plurality of SATA devices 138. The SATA host 130 identifies a SATA device 138 coupled to the port multiplier 136 to which a SATA FIS is directed through a Port Multiplier Port (PMP) field in a FIS. For example, with four bits, the PMP field can identify one of 15 SATA devices 138 coupled to the port multiplier 136.

A First Party Direct Memory Access (FPDMA) write command flow includes a series of frames that are exchanged between a host and a device as discussed in the SATA standard. First the host transmits a FPDMA write command that includes an NCQ tag. In response to the FDMA write command, the device sends a D2H Register FIS to clear the BSY bit. Then the device sends a DMA Setup FIS that includes an NCQ tag to the host. Then the host and device exchange Data FIS and DMA Activate FIS to transmit the data to the device as an atomic data operation. After the data has been transmitted to the device, the device transmits an SDB FIS to the host indicating that the data transfer is complete for the FPDMA write command.

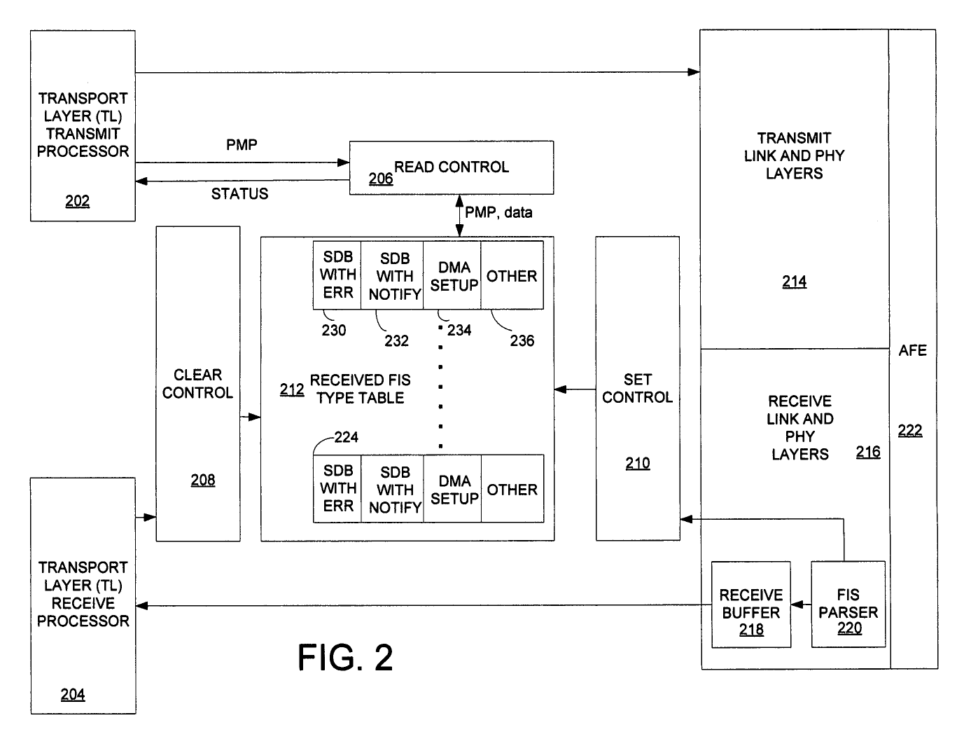

FIG. 2 is a block diagram of an embodiment of a system that includes an embodiment of the FIS type manager 132 shown in FIG. 1. The FIS type manager 132 includes a received FIS type table 212 which is accessible from a transport layer 202, 204 and link layer 214, 216. A receive buffer (or receive FIFO) 218 may be used to enqueue received frames (FISes) in order.

In the embodiment shown, the FIS received type table 212 has multiple entries 224. The number of entries is dependent on the number of supported devices. Each entry is associated with one of the SATA devices 138 accessible through the port multiplier 136 shown in FIG. 1. Each entry 224 in the received FIS type table 212 has a plurality of fields with each field associated with a different type of received FIS (frame). For example, in the embodiment shown in FIG. 2, each entry 224 includes the following fields for the following types of FIS: SDB FIS with Error field 230, SDB FIS with Notification field 232, Direct Memory Access Setup (DMA) FIS 234, or any other received type of FIS 236 associated with a stall condition, that is, that may result in a stall in the transport layer transmit processor 202.

The Port Multiplier Port (PMP) field in a received FIS may be used as an index to select the entry in the received FIS type table 212 that is associated with the SATA device from which the FIS was received. Each entry in the received FIS type table 212 is indexed by the value stored in the Port Multiplier Port (PMP) field that is included in both a transmit FIS and a receive FIS. In an embodiment, each field in the entry 224 has a single bit which may be set (logical ‘1’) or clear (logical ‘0’) to indicate whether the particular type of FIS has been received from the SATA device 138 associated with the entry 224.

A FIS type parser and checker (FIS parser) 220 in the receive link and phy layers 216 parses each FIS received from the Analog Front End (AFE) 222. Upon receiving a FIS, the FIS parser 220 performs a Cyclic Redundancy Check (CRC) check and extracts the PMP from the PMP field in the FIS.

The FIS parser 220 also decodes the FIS type that is included in the received FIS, validates the FIS to be legitimate and stores the FIS in a receive buffer 218. In an embodiment, prior to storing the received FIS in the receive buffer 218, the PMP, extracted FIS type and an indication as to whether there is an error or notification is forwarded to set logic 210. The set logic 210 sets one of the fields 230, 232, 234 in the entry 224 in the received FIS Type Table 212 that is indexed by the PMP extracted from the received FIS. The field selected to be set is dependent on the FIS type and whether the FIS is associated with a stall condition.

For example, if the received FIS is an SDB FIS with Error, that is the error bit in the status field in the received FIS is set, and the PMP field is set to ‘10’, after the FIS parser 220 validates the received FIS, the SDB with error field 230 in the entry 224 in the received FIS type table 212 indexed by PMP=‘10’ is set.

Thus, each entry 224 provides an indication of the type of FIS associated with a stall condition for SATA device 138 associated with the entry 224 that are stored in the receive buffer 218. Prior to issuing a FIS to one of the SATA devices 138, the transport layer transmit processor 202 may request an indication of whether there are any receive FISes associated with a stall condition stored in the receive buffer for the SATA device.

In an embodiment, the transport layer transmit processor 202 forwards the PMP associated with the SATA device 138 to read control logic 206. The read control logic 206 reads the entry 224 in the received FIS table 212 indexed by the PMP, examines the state of the fields in the indexed entry 224. If all fields are clear, the FIS may be transmitted to the SATA device associated with the PMP. The status returned to the transmit layer transmit processor 202 indicates that the FIS may be transmitted through the transmit link and phy layers 214 and AFE 222 to the port multiplier 136.

As each FIS is processed and removed from the receive buffer 218 by the transport layer receive processor 204, a request is issued to clear logic 208 to clear the field associated with the FIS in the indexed entry 224 in the received FIS type table 212. Thus, the received FIS type table 212 provides an indication of the type of FISes stored in the receive buffer 218 for each of the 15 SATA devices that may be accessed through the port multiplier 136. The transmit layer transmit processor 202 may monitor the type of FIS stored in the receive buffer 218, defer FISes to be transmitted to SATA devices that are stalled and transmit FISes to SATA devices 138 that can accept the FISes.

In an embodiment, the FIS type manager 132 may be integrated into a SATA/STP receive buffer architecture to support a system that includes a FIS-based switching Port Multiplier 136.

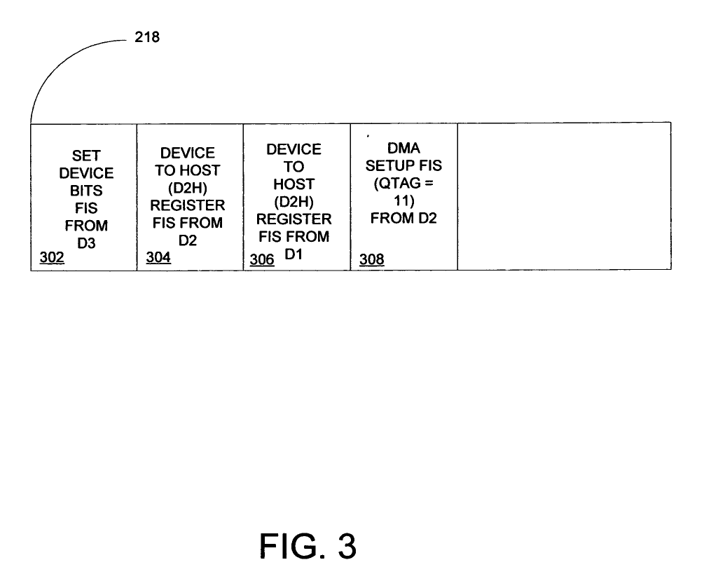

FIG. 3 is a block diagram of an embodiment of the receive buffer 218 shown in FIG. 2 which may store a plurality of received FISes or frames. FIG. 3 will be described in conjunction with FIGS. 1 and 2.

In the embodiment shown, the receive buffer 218 stores FISes received from SATA devices D1, D2 and D3 that are accessible through port multiplier 136 as shown in FIG. 1.

The first entry 302 in the receive buffer 218 stores a Set Device Bits FIS that has been received from SATA device D1. The second entry 304 in the receive buffer 218 stores a Device to Host (D2H) Register FIS that has been received from SATA device D2. The third entry 306 in the receive buffer 218 stores a Device to Host Register FIS received from device D1. The fourth entry 308 in the receive buffer 218 stores a DMA Setup FIS with a NCQ tag of 11 received from device D2.

As the FISes are received and stored in the receive buffer 218, the fields associated with the type of FIS in the associated entries 224 in the received FIS type table 212 are set. In this example, the only FIS type associated with a stall condition is the DMA Setup FIS received from device D2. Thus, in the entry 224 in the FIS type table 212 indexed by the PMP for device 2, the DMA Setup field 234 is set, all the fields in the entry in the received FIS type table 212 indexed by the PMP for devices D1 and D3 are clear.

Thus, the transport layer transmit processor 202 through the read control logic 206 can determine that FISes cannot be transmitted to SATA device D2 but that FISes can be transmitted to SATA devices D1 and D3. Therefore, FISes can continue to be transmitted to devices D1 and D3 even though the receive buffer 218 stores a DMA Setup FIS which would have stalled transmission of all FISes to all of the devices.

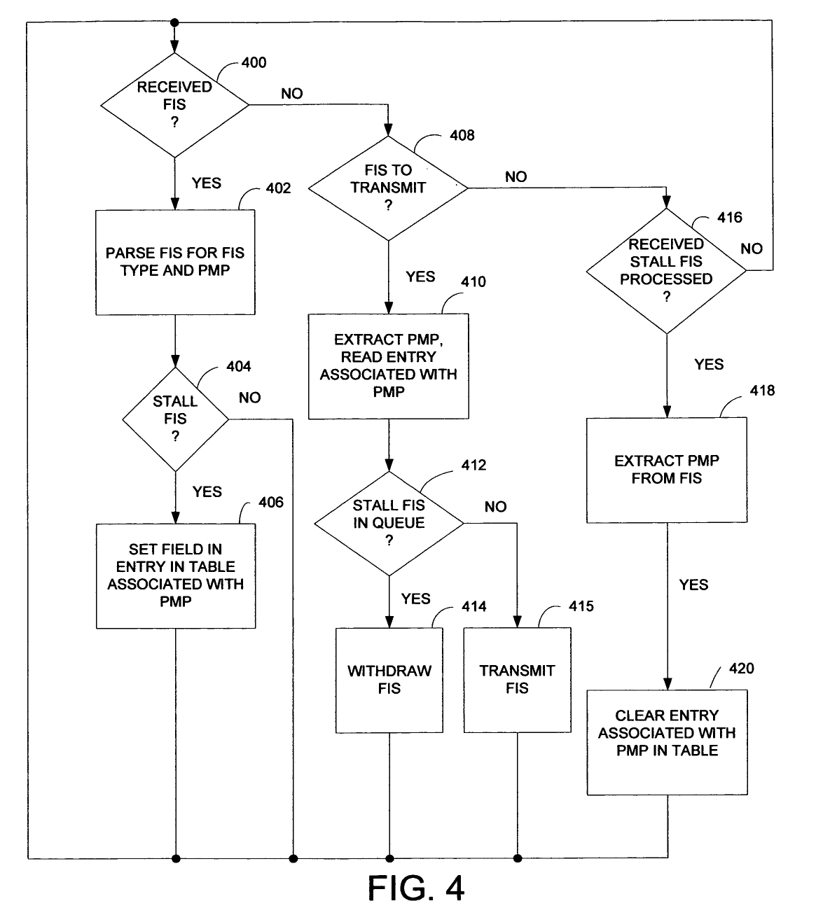

FIG. 4 is a flow graph illustrating an embodiment of a method for managing transmission of FISes to SATA devices by monitoring received FISes stored in a receive buffer.

At block 400, the FIS parser 220 waits for a FIS to be received from the AFE 222. Upon receiving a FIS, processing continues with block 402.

At block 402, the FIS parser 220 extracts the PMP and FIS type from the received FIS. Processing continues with block 404.

At block 404, the if the received FIS type is associated with a stall condition, that is, a SDB FIS with error, SDB FIS with notification, DMA Setup FIS or other FIS type that results in a stall condition in the transmit path, processing continues with block 406.

At block 406, the set logic 210 receives the PMP, FIS type, and error or notification indications and sets appropriate fields in the entry 224 in the received FIS type table 212 to identify the received FIS type. Processing continues with block 400.

At block 408, the transport layer transmit processor 202 waits for a new command to send to a device. Upon receiving a new command to send, processing continues with block 410.

At block 410, the transport layer transmit processor 202 has a new command to send to a device, for example, device D1, the transport layer transmit processor 202 extracts the Port Multiplier Port (PMP) number from the command FIS that is associated with D1 and forward the PMP to the read control 206. The read control 206 reads all fields of the entry 224 in the received FIS type table 212 indexed by the PMP. In one embodiment, the read control 206 returns the contents the entry to the transport layer transmit processor 202. In another embodiment, instead of returning the entire contents of the entry 224, the read control 206 returns an indication as to whether a FIS associated with a stall condition has been received for the device, that is, whether one of the fields in the indexed entry 224 is set. Processing continues with block 412.

At block 412, if there is a FIS associated with a stall condition received for the device that is stored in the receive buffer 218, processing continues with block 414. If there is no FIS associated with a stall condition received for the device stored in the receive buffer 218 as indicated by the contents of the entry 224 associated with the device, processing continues with block 415.

At block 414, the transport layer transmit processor 202 withdraws the new command transmission to device D1. For example, if the ‘DMA Setup FIS Field’ 234 is set, a DMA Setup FIS has been received from device D1, and has not yet been processed by the receive path. Thus, the transport layer transmit processor 202 does not send the command FIS transmission request to device D1. Instead, the transport layer transmit processor 202 withdraws the command transmission and re-transmits the to-be-transmitted command at a later time.

The transport layer transmit processor may service another task to a different device, for example, device D2, if the current task will be retransmitted at a later time. For example, the to-be-transmitted command to device D1 may be retransmitted at a later time due to a received DMA Setup FIS, a received SDB with error status or a received SDB with notification status as indicated by the contents of the entry 223 associated with the PMP for device D1.

For example if the ‘Set Device Bits FIS with error field 230 is set in the entry in the table corresponding to the PMP in the FIS. This indicates that an error has occurred from device D1 After detecting an error, the transport layer transmit processor 202 does not transmit any new command FIS to device D1. The transport layer receive processor 204 services the received Set Device Bits (SDB) FIS with Error status from device D1 and performs an error handling routine associated with device D1.

After the transport layer transmit processor 202 withdraws the new command transmission to device D1, it may work on the next task to a device other than device D1, for example, device D2, if there is a task to be performed for device D2. Processing continues with block 400.

At block 415, all of the corresponding status bits are clear, the transport layer transmit processor 202 performs a normal frame transmission procedure to complete the frame transmission. Processing continues with block 400.

At block 416, if the transport layer receive processor 204 has completed processing a FIS in the receive buffer and the FIS is associated with a stall condition, processing continues with block 418. If not, processing continues with block 400.

At block 418, the transport layer receive processor 204 extracts the PMP from the completed FIS associated with a stall condition and forwards the FIS type, for example, SDB with error, SDB with notify or DMA Setup FIS to clear logic 208.

At block 420, the clear logic 208 clears the bit in the entry 224 in the received FIS type table 212 associated with the device for which the FIS was processed. For example, the ‘DMA Setup FIS’ field 234 in the entry 224 in the Received FIS type table 212 indexed by the PMP for device D1 may be cleared via the clear logic 208. Processing continues with block 400.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
a table comprising a plurality of entries, each entry associated with a Serial Advanced Technology Attachment (SATA) device accessible through a port multiplier and providing an indication of a received frame associated with a stall condition received from the SATA device, the received frame to be stored in a receive buffer; and
control logic to provide access the table to a transport layer transmit processor to monitor the received frame associated with a stall condition stored in the receive buffer and to allow the transport layer transmit processor to continue to transmit to SATA devices other than the SATA device from which the frame associated with a stall condition was received.

2. The apparatus of claim 1, wherein upon receiving the frame associated with a stall condition, the control logic selects an entry based on a port multiplier field stored in the frame and sets a field in the entry associated with the received frame.

3. The apparatus of claim 1, wherein after completion of processing the frame associated with a stall condition, the control logic selects an entry based on a port multiplier field stored in the frame and clears a field in the entry associated with the received frame.

4. The apparatus of claim 1, wherein the control logic based on a port multiplier field stored in another frame to be transmitted to the device by a transport layer transmit processor provides an indication of whether the frame associated with a stall condition is stored in the entry associated with the device.

5. The apparatus of claim 1, wherein the frame associated with a stall condition is a Direct Memory Access (DMA) Setup Frame Information Structure (FIS).

6. The apparatus of claim 1, wherein the frame associated with a stall condition is a Set Device Bits (SDB) Frame Information Structure (FIS) with an error bit set.

7. The apparatus of claim 1, wherein the frame associated with a stall condition is a Set Device Bits (SDB) Frame Information Structure (FIS) with a notification bit set.

8. The apparatus of claim 1, wherein the SATA device supports Native Command Queuing (NCQ).

9. A method comprising:
storing a table comprising a plurality of entries, each entry associated with a Serial Advanced Technology Attachment (SATA) device accessible through a port multiplier and providing an indication of a received frame associated with a stall condition received from the SATA device;
storing the received frame in a receive buffer;
providing access to the table to a transport layer transmit processor to monitor the received frame associated with a stall condition stored in the receive buffer; and
allowing the transport layer transmit processor to continue to transmit to SATA devices other than the SATA device from which the frame associated with a stall condition was received.

10. The method of claim 9, wherein upon receiving the frame associated with a stall condition, the control logic selects an entry based on a port multiplier field stored in the frame and sets a field in the entry associated with the received frame.

11. The method of claim 9, wherein after completion of processing the frame associated with a stall condition, the control logic selects an entry based on a port multiplier field stored in the frame and clears a field in the entry associated with the received frame.

12. The method of claim 9, wherein the control logic based on a port multiplier field stored in another frame to be transmitted to the device by a transport layer transmit processor provides an indication of whether the frame associated with a stall condition is stored in the entry associated with the device.

13. The method of claim 9, wherein the frame associated with a stall condition is a Direct Memory Access (DMA) Setup Frame Information Structure (FIS).

14. The method of claim 9, wherein the frame associated with a stall condition is a Set Device Bits (SDB) Frame Information Structure (FIS) with an error bit set.

15. The method of claim 9, wherein the frame associated with a stall condition is a Set Device Bits (SDB) Frame Information Structure (FIS) with a notification bit set.
